(19) United States
(12) Patent Application Publication
(10) Pub. No.: US 2023/0111111 A1
(43) Pub. Date: Apr. 13, 2023

(54) ARTICLE COMPRISING MULTIPLE MATERIAL LAYERS WITH REDUCED THICKNESS

(71) Applicant: Nexe Innovations Inc., Surrey (CA)

(72) Inventors: Darren Joseph Footz, Surrey (CA); Kianoush Karmini Pour Kerman, Vancouver (CA); Zachary M. Hudson, Surrey (CA)

(21) Appl. No.: 17/748,993

(22) Filed: May 19, 2022

Related U.S. Application Data
(60) Provisional application No. 63/190,652, filed on May 19, 2021.

(51) Int. Cl. B32B 23/08; B65D 85/804; B65D 65/46; B32B 27/10

(52) U.S. Cl. CPC B32B 23/08; B65D 85/8043; B65D 65/466; B32B 27/10; B32B 2307/732; B32B 2307/7163

(57) ABSTRACT

Proposed is an apparatus and method for creating a formed article comprised of at least one layer of thermoplastic and at least one layer of cellulose fibers to create a composite article. The formed article may additionally be compressed to further reduce its thickness and improve its look and feel as well as mechanical properties.

### CROSS-REFERENCE TO RELATED APPLICATIONS

The present application claims the priority benefit of U.S. provisional patent application 63/190,652 filed May 19, 2021, the disclosure of which is incorporated herein by reference.

### FIELD OF THE DISCLOSURE

The present disclosure relates to a beverage cartridge such as, for example, a compostable beverage cartridge for single-serve use. The present disclosure further relates to methods of manufacture and uses thereof. The present disclosure further relates to Injection molding techniques and the articles they produce, particularly composite materials made of bioplastics and cellulose fibers.

### BACKGROUND

Single-serve beverage cartridges have become a dominant method for serving beverages, especially hot beverages, in a variety of settings such as homes, offices, waiting rooms, hotel rooms and lobbies, and other places where people consume beverages. The rapid growth of single-serve beverage cartridges is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location, or locations of origin, etc.

The convenience and variety of single serving beverage cartridges allows and encourages consumers to prepare and consume a plurality of beverages throughout the day. This pattern of consumption causes the rapid accumulation of used beverage cartridges wherever they are consumed. Due to the nature of single-serving beverage cartridges, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines containers and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

Single-serve beverage cartridges typically comprise several components made of various materials. The typical components of a single-serve beverage cartridge include, at least, a container, typically made from plastic such as polyethylene, a filter, typically made from plant fiber such as abacá fibers or other natural and synthetic fibers, and a container lid, typically made from food-grade aluminum foil, which is also commonly printed upon to include product labelling. Some beverage cartridges do not contain a filter, typically because the beverage material is readily soluble in hot water (such as, for example, hot cocoa). The container will usually comprise an opening on the top of the container, and a hollow cavity within which and across which a filter may be disposed. The container may also comprise an opening at on the bottom container. After the filter and beverage material are inserted into the container, the lid is then typically sealed over the container opening or openings. The sealed lid typically provides an airtight seal, preventing the exchange of gases between the environment and the interior of the container, thus preventing oxidation and/or spoilage of the beverage material. In beverage cartridges that comprise a filter, the filter may separate the container into two chambers: a first chamber occupying the space within the container between the filter and the opening of the container, the first chamber for holding dry beverage ingredients such as, but not limited to, coffee, tea, or cocoa, for a single beverage serving; and (ii) a second chamber occupying the space within the container between the filter and the base of the container, the second chamber being on the opposite side of the filter to the first chamber. The purpose of the second chamber is typically to provide a space in which a fluid extractor of a beverage brewing device may be inserted into the bottom of the container, entering the second chamber and allowing the extraction of fluid from the cartridge without the fluid extractor entering the first chamber, such that fluid flows through the beverage material and the filter before exiting the cartridge via the fluid extractor. However, the presence of the second chamber may significantly reduce the space within the container that can be occupied by beverage medium. This may be problematic as the total amount of beverage material disposed within the container may significantly contribute to the final concentration of the beverage, typically measured in Total Dissolved Solids (TDS). It may be advantageous to minimize the volume of the second chamber in order to maximize the volume on the third chamber, thereby maximizing the total volume available for beverage material. However, the fluid extractor is typically comprised of a sharp, hollow needle-like piercing element designed to easily pierce through the bottom of the container, such that if the second chamber is reduced in size, the fluid extractor may penetrate or damage the filter, allowing the beverage material to exit the first chamber, and ultimately exit the cartridge via the fluid extractor. Thus, in the event the fluid extractor penetrates or damages the filter, the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

The cover is disposed over the opening of the container (which may be, for example, over the top of the container, and/or bottom of the container), and keeps the dry beverage ingredients within the container, as well as providing an airtight seal to prevent the oxidation and other types of degradation of the container's contents. In practice, a single-serving beverage cartridge is placed into a compartment of a brewing machine. The machine is activated such that a fluid injector penetrates the cover of the cartridge and a fluid extractor penetrates the base of the cartridge (which may also be a cover). The fluid injector injects a brewing medium (e.g., hot water) into the first chamber for extracting beverage components from the ingredients. The brewing medium containing the extracted beverage components percolates through the filter and into the second chamber. The brewing medium containing the extracted flavors is then extracted by the fluid extractor and finally dispensed as a drinkable beverage.

Currently, the container of a beverage cartridge for single-serve use is typically made from petroleum-based plastic materials which are neither biodegradable nor compostable. In some cases, the container may be made of petroleum biodegradable materials, such as Polybutylene adipate terephthalate (PBAT). Biodegradation is the decay of organic substances, such as dead plant matter, which are allowed to decompose to the point that various waste products provide nutrients to soil. Biodegradation can be aerobic and/or anerobic depending on the environment. Aerobic is the decomposition of organic matter by microbes that require oxygen to process the organic matter. The oxygen from the air diffuses into the moisture that permeates the organic matter, allowing it to be taken up by the microbes. Anerobic biodegradation is the decomposition of organic matter by microbes that do not require oxygen to process the organic matter. To be anerobic, the system should be sealed from the air, such as with a plastic barrier. Anerobic compositing produces an acidic environment to digest the organic material. A portion of the organic matter may additionally be converted to vermicast, or castings from worms or other animals.

The cover of a beverage pod is typically made of a metal foil (e.g., aluminum) or a metal foil laminate which is glued to the top of the container. Generally, neither the metal foil of the cover nor the glue affixing the cover over the opening of the container is biodegradable, compostable or made from readily renewable resources. As a result, non-biodegradable and non-compostable beverage cartridges typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which effect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process can be partially automated; however it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage containers, such as instant beverage cups or pods, are particularly difficult to recycle. Not only do they have non-recyclable material contained within them that would first need to be removed, but they are also frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling; however, this inconvenience will inevitably result in consumers recycling the beverage containers without proper preparations, or failing to recycle the container at all, electing to discard the container as trash. One of the major advantages of using beverage pods is consumer convenience, such that a beverage can be prepare by simply inserting a cartridge into a machine that performs all other brewing functions. It is therefore undesirable to instruct consumers to disassemble and sort various materials from the beverage pod, and due to the diminutive size of beverage pods, this may not be physically possible for consumers without fine motor skills necessary to disassemble such an item. The result is a required step of preprocessing the containers before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based or those which originate from biomass, are biodegradable. Only a small subset of these is also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are OXO-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from microplastics, as the plastic molecules themselves do not degrade any faster than their traditional plastic counterparts. There have been efforts in some jurisdictions to ban these plastics.

Bioplastics are sustainable materials, however they may not have the desired physical properties for a given application. As such, methods of processing and reinforcing the material are required to achieve the necessary properties for applications such as use as a disposable and biodegradable beverage pod. In particular, bioplastics tend to be brittle and are prone to failure at high temperatures and when subjected to mechanical stresses. Moreover, many bioplastics may not have a look and feel typical of a compostable product, causing consumer confusion and hesitancy. Some materials, like cellulose fiber, have a desirable look and feel, and potentially desirable mechanical and structural properties, but do not offer the same benefits as bioplastics, in particular, the air and moisture barrier needed to prevent degradation of the beverage material (e.g., coffee grounds).

There is significant challenge creating a compostable beverage pod with all desirable properties, including look and feel, mechanical strength, air and moisture barrier, etc. It is possible to achieve these properties by nesting various materials, e.g., a cellulose fiber outer shell with a bioplastic inner liner nested within. The additional material may, however, create other issues. The fixed size of the brewing chamber of a beverage brewing device may place limitations on the total volume and dimensions the beverage pod may occupy. This means that nesting materials may reduce the inner volume of the beverage pod available for beverage material. Reduction in the volume available for beverage material may thus reduce the concentration of extracted beverage material in the final beverage, thus creating an inferior beverage for some consumers. Moreover, layering materials this way can create other issues. The brewing drain pin inside the brewing chamber of a beverage brewing device has a fixed penetration depth in which it can effectively drain brewed beverage liquid from the beverage pod. Nested materials may cause the brewing drain pin to fail to fully penetrate into the interior of the beverage pod, thus preventing the brewed beverage from being released to the consumer. It may be necessary, in some cases, to remove the outer cellulose fiber shell from the bottom of the beverage pod by die-cutting the bottom of the cellulose fiber shell, but this is not idea for several reasons. First, the die-cutting process increases total time an energy needed to produce a finished compostable beverage pod, thus causing a significant increase in cost for the manufacturer at high volumes. Second, removing the bottom of the cellulose fiber capsule exposes the bioplastic inner liner, removing a portion of the desirable look and feel created by the cellulose fiber exterior.

While composite materials comprising fibers and plastics can mechanically strengthen a formed article, the forming methods can be challenging. Introducing fibers directly into the plastic material prior to forming can cause equipment to clog and the distribution of the fibers may be insufficient to provide the necessary strength to the formed article. Additionally, producing a formed article using layered techniques can create additional problems such as increasing the thickness of the formed article, delamination of the layers, and challenges forming an article comprised of multiple layers in an economical process. There exists a need to create a beverage capsule that can provide the benefits of the cellulose fiber exterior and the bioplastic interior without the associated problems on nesting or layering the materials. In order to achieve this, several injection modeling processes may be used in tandem and require some definition. Compression refers to the insertion of a part into a mold, wherein the mold applies pressure to the part in order to modify a physical property of the part. For example, the cellulose outer shell may be inserted into a mold and compression may be applied to the mold, effectively reducing the thickness of the cellulose fiber walls by flattening the fibers. This is possible due to the compressibility of cellulose fiber, or its capacity to be flattened or reduced in size by pressure. Labeling refers to injection molding a bioplastic into a mold that is already occupied by a part. For example, a cellulose fiber shell may be placed in the mold of an injection molding device, and the gates may allow a bioplastic to flow into the interior of the mold. Thus, the bioplastic effectively “labels” the cellulose fiber part placed inside the injection mold, creating a surface layer of bioplastic uniformly about the interior or exterior of the cellulose fiber part. Coining, also known as injection-compression refers to applying compressive force to an injection mold while liquid material has flowed into the mold interior. Coining may increase melt distribution as well as reducing the thickness of the walls of the molded part. Finally, additional compression may be applied to a part after one or more of the above steps. A compressed fiber shell may be labelled with a bioplastic, coining compression forces may be applied to evenly distribute and reduce final thickness of the bioplastic label, and then addition compression forces may be applied to further reduce the thickness of the ways of the combine materials.

The described method of forming a composite article from plastics and cellulose fibers can improve the mechanical properties and look and feel of an article formed by this method compared to one formed only using plastic while reducing production time and costs and improving reliability of the production process. Further, reducing the thickness of the articles walls may increase the volume available for beverage material, which can increase the total dissolved solids (TDS) of the brewed beverage, improving beverage quality and organoleptic experience of the brewed beverage for some consumers.

### BRIEF DESCRIPTIONS OF THE DRAWINGS

FIG. 1: Illustrates a compostable beverage pod, according to an embodiment.

FIG. 2: Illustrates a Beverage Pod, according to an embodiment.

FIG. 3: Illustrates a Forming Apparatus, according to an embodiment.

FIG. 4: Illustrates a Compression Mold, according to an embodiment.

FIG. 5: Illustrates a Forming Module, according to an embodiment.

### DETAILED DESCRIPTION

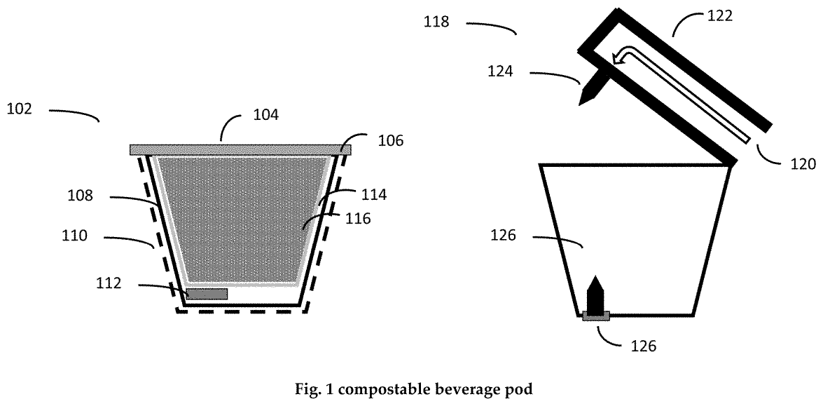

FIG. 1 is a system for a compostable beverage pod. This system comprises of a beverage pod 102, or beverage cartridge, which may be a container, pod, capsule, etc., for use in a beverage brewing machine 118, such as a coffee maker. They may include one or more of, a beverage material 116 that is either soluble or insoluble, one or more filters 114 and a first portion in which liquid is passed into and a second portion through which liquid passes out of the beverage pod 102. In some instances, they are portioned beverage pods 102 often contain a water-soluble beverage material 116, to make a drink such a hot chocolate, chai tea, etc. These portioned beverage pods 102 can be pouches as well as pods for beverage brewing machines 118. element 102. A pod lid 104, capsule lid, or cartridge lid, is a component of a beverage pod 102, often made of foil, that is sealed to the pod, cartridge, capsule, etc., so as to contain the beverage material 116. A compostable pod 104 lid may be comprised of, for example a cellulose paper laminated with PLA and/or PBAT (which may contain a proportion of PHA, in some embodiments). element 104. The pod bond 106 is the connection between any two of the pod lid 104, pod exterior 108, and a second layer 110. This pod bond 106 can be mechanical or chemical, and such as adhesives, heat sealing, ultrasonic welding, etc. A filter bond is a type of pod bond 106 that binds the filter 114 to a portion of the capsule, such as by ultrasonic welding, adhesives, thermal sealing, etc. The pod bond 106 and the filter bond can be in one place or separately depending upon the use case. element 106. A pod exterior 108, or capsule, or cartridge is the outer shell of the beverage pod 102. The exterior 108 can be made of plastic (especially compostable plastic, such as PLA, PHA, PBAT or combinations thereof), cellulose, etc. It has similar properties to other thermoplastic polymers such as polypropylene (PP), polyethylene (PE), or polystyrene (PS). This allows it to serve as a biodegradable alternative for beverage pods 102. It can also be made from polyhydroxyalkanoates (PHAs), which are a biodegradable polyester produced through bacterial fermentation of sugar or lipids. They can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage pod 102. PLLA is also readily renewable, typically made from fermented plant starch such as from corn, cassava, sugarcane or sugar beet pulp. Cellulose fibers are fibrous materials made from plant materials such cotton, flax, wood pulp, etc. They provide a biodegradable filter 114 material that could be used in beverage pod 102 filters 114. Other materials that are biodegradable plastic alternatives include petroleum-based plastics such as, polyglycolic acid (PGA), polybutylene succinate (PBS), polycaprolactone (PCL), polyvinyl alcohol (PVOH), polybutylene adipate terephthalate (PBAT), and ethylene vinyl alcohol (EVOH). element 108. Beverage pods 102 can also contain a second layer 110 that is separate from a filter 114, in beverages that have an insoluble beverage material 116 such as coffee. The second layer 110 can be used for a number of purposes, including, providing material properties such as structural integrity (e.g., provide addition strength to resist the pressure of liquid injection in the process of brewing a beverage, which may crack or otherwise compromise the beverage pod 102), or altering the biodegradability or rate of the beverage pod 102 in some embodiments. The second layer may be within the pod exterior 108, or may be arranged outside the pod exterior 108. In an embodiment, the second layer 110 is formed of pressed cellulose fibers which are fused to the exterior of a pod exterior 108 made of PLA or a mixture containing PLA. The pod exterior 108 may alternatively be made of any other thermoplastic material. element 110. A faceplate 112, is a solid structure integrated into a beverage pod 102 that prevents the outlet 128 piercing element from creating a path for the insoluble beverage material 116 from inside the filter to the outlet 128. In some embodiments, the optional second layer may include integrated features to act as a faceplate 112, removing the requirement for a discrete component. element 112. A filter 114 is a medium, such as spun bond PLA web, paper (cellulose), cloth or metal, that is used to prevent an insoluble beverage material 116 from leaving the beverage pod 102 and entering the beverage brewing machine 118 or the beverage. Filters 114 can be symmetrical (e.g., fluted), or asymmetrical (e.g., pleated). element 114. Beverage material 116 is the material used to produce a brewed beverage, such as coffee grounds, tea, or a mix beverage where the beverage material 116 is soluble, such as hot chocolate. Beverage material 116 may include any flavorings, nutritional content (e.g., any oils, nutritional supplements, active ingredients such as pharmaceuticals, cannabinoids, etc.), alcohol, coloring, or any other composition which has an effect on the final beverage. element 116. Beverage brewing machines 118 for brewing portioned beverages from pre-packed beverage pods 102 exist for a variety of beverages made from a beverage material 116 that is either insoluble, such as coffee, or soluble, such as hot chocolate. A beverage brewing machine 118 will typically contain many other components, such as, for example, a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing machine 118 contains all components necessary to accomplish the beverage brewing process, though specific reference to beverage brewing machine 118 components may only be made to those components which come into direct contact with the beverage pod 102, such as the brewing chamber 126, a fluid injecting component, such as a brewing pin 124, and a fluid extracting component such as an outlet 128. element 118. A fluid source 120 supplies the liquid, usually water, to the beverage brewing machine 118 for producing the desired beverage. element 120. A brewing chamber lid 122 opens to allow a new beverage pod 102 to be added to the beverage brewing machine 118, and in many of the most common embodiments of a beverage brewing machine 118, the chamber lid 122 connects the fluid source 120 to the brewing pin 124, but the fluid source 120 does not have to be in the brewing chamber lid 122. element 122. A brewing pin 124, or fluid injecting component, typically has a piercing element to puncture the beverage pod lid 104, that provides a liquid, typically hot water, to mix with the beverage material 116 to create the beverage. element 124. A brewing chamber 126 is a receptacle or sieve holder, into which the beverage pod 102 is placed so that a beverage can be brewed. element 126. An outlet 128, or fluid extracting component, typically has a piercing element to puncture the bottom of the beverage pod 102 to allow the brewed beverage to leave the brewing chamber 126. Depending upon the embodiment, it may pierce or deform other components of the beverage pod 102. element 128. A forming apparatus 130 is a part of an injection molding machine comprising at least a Compression Mold 132, a Labeling and Coining Mold 136, a Final Compression Mold 138, and one or more transfer actuators 134 for moving an article from the Compression Mold 132 to the Labeling and Coining Mold 136 and optionally moving an article from the Labeling and Coining Mold 136 to the Final Compression Mold 138. One skilled in the art will appreciate that the Compression Mold 132, Labeling and Coining Mold 136, and Final Compression Mold 138 may be separate molds occupying separate areas of the forming apparatus 130, or may be, in some embodiments process stages of a single mold in the forming apparatus. In embodiments where the Compression Mold 132, Labeling and Coining Mold 136, and Final Compression Mold 138 are process stages of a single mold, transfer actuators 134 may not be needed, and instead more typical injection molding ejection mechanisms may be used. Typical injection molding ejection mechanisms may include, for example, pressurized air or other fluid pressure, mechanical force, gravity, or any other means of ejecting a finished part from an injection molding apparatus. The forming apparatus 130 may be comprised of metal or a metal alloy and/or heat resistant materials including ceramics and plastics. In some embodiments, the function of the Labeling and Coining Mold 136 may be included in the Compression Mold 132 eliminating the need for discrete molds. Alternatively, the Compression Mold 132 and the Labeling and Coining Mold 136 may share a common component, such as half of the mold may be used as part of both the Compression Mold 132 and the Labeling and Coining Mold 136. element 130. A Compression Mold 132 is a component of a forming apparatus 130 for compressing an article comprised of a compressible material, such as, for example, cellulose fiber. In one example, an article comprised of cellulose fiber may be, for example, a beverage pod exterior made from molded paper pulp. Due to the process of manufacturing molded paper pulp articles, the article may have a wall thickness that exceeds optimal thickness for a given application, which may be, for example, a beverage pod. A beverage pod with walls thicker than is optimal may be difficult to penetrate by the brewing pin of a beverage brewing device, and thus prone to failure if the brewing fails to fully pierce the beverage pod. A compression mold 132 may be used to compress the article, reducing the thickness of the article. A Compression Mold 132 may be made of metal or a metal alloy and/or other heat resistant materials including ceramics and plastics. The Compression Mold 132 is supplied an article by transfer actuators 134 or some other mechanisms, such as, for example, gravity feeding, pneumatic tubes, a mechanical cartridge, or some other means. Once the compression mold 132 is supplied an article, it applies compressive force and potentially other energetic forces, such as heat or ultrasound, to the article create a compressed article. The force needed to compress the article may depend on several factors including the thickness of the uncompressed article, the thickness of the desired compressed article, the material composition of the article, the material and operating parameters of the compression mold 132, etc. Some materials may become more compressible at higher temperatures, and in some embodiments, the compression mold 132 may adjust the compression force and/or operating temperature based, at least in part, on the material composition of the article. The Compression Mold 132 may be comprised of a single component, such as in blow molding, where the article is inserted into a female portion of the mold and fluid pressure, such as forced air, is applied to the article to cause compression, or the Compression Mold 132 may be comprised of at least two components, such as a core mold and a cavity mold, so that the core mold nests within the cavity mold to create a void which accepts and compresses a compressible article. The core mold and cavity molds may then separate to allow removal of the compressed article from the Compression Mold 132. element 132. A transfer actuator 134 is a movable component which may use an end effector to move a compressed article from a Compression Mold 132 to a Labeling and Coining Mold 136. The transfer actuator 134 may additionally be used to insert an uncompressed cellulose article into the Compression Mold 132. In alternate embodiments, the transfer actuator 134 may move one half of the Compression Mold 132 or the Labeling and Coining Mold 136 so as to transfer the formed article to the Labeling and Coining Mold 136. In some embodiments, the transfer actuator may be a robotic arm assembly capable of suctioning or other grasping one or more articles from one or more first molds and transferring the one or more articles to one or more second molds. element 134. A Labeling and Coining Mold 136 is a component of a forming apparatus 130 for forming a labeled and/or coined article from a compressed article transferred from the compression mold 132 via the transfer actuator 134 using a thermoplastic or a blend of thermoplastic materials. A Labeling and Coining Mold 136 may be made of metal or a metal alloy and/or other heat resistant materials including ceramics and plastics. The Labeling and Coining Mold 136 is supplied by an injection nozzle, known as a gate, which forces a thermoplastic material which has been heated past its melting point such that the thermoplastic material flows into the Labeling and Coining Mold 136 with or without additional pressure. In alternate embodiments, the forming mold may be used in a process of injection blow molding, injection stretch blow molding, compression molding, thermoforming, or rotational molding. The Labeling and Coining Mold 136 may be comprised of a single component, such as in blow molding, or the Labeling and Coining Mold 136 may be comprised of at least two components, such as a core mold and a cavity mold, so that the core mold nests within the cavity mold to create a void which is filled with a thermoplastic material to create a formed article. The core mold and cavity molds may then separate to allow removal of the formed article from the Labeling and Coining Mold 136. In one instance, the Labeling and Coining Mold 136 may be supplied thermoplastic material through one or more gates on the core side of the mold. In such embodiments, thermoplastic is injected into the interior of a compressed article, such as a cellulose fiber compostable beverage pod capsule. In such an embodiment, the interior surface of the cellulose fiber compostable beverage pod capsule is effectively labeled with the thermoplastic, e.g., a thin layer of thermoplastic completely labels the interior surface of the cellulose fiber compostable beverage pod capsule. In some embodiments, the liquid thermoplastic injected into the gates of the Labeling and Coining Mold 136 may be subjected to compression while the thermoplastic remains in the liquid phase or in a near-liquid phased, which may be referred to as a coining process. A coining process creates a thinner and more uniform layer of thermoplastic in an injection mold than may be possible without a coining process. Labeling and Coining Mold 136 is thus capable of injecting thermoplastic into at least one side of the mold (core mold or cavity mold) to create a thermoplastic label on an article, and then use a coining process to achieve a target thickness and other properties of the thermoplastic label (such as, for example, crystal structure, mechanical properties, heat resistance, etc.). In some embodiments, the labeled and coined thermoplastic may be allowed to cool to a set temperature, and then subject to heat to produce annealed article with improved properties, such as improved thermal resistance. element 136. A Final Compression Mold 138 is a feature of forming apparatus 130 which applies pressure and/or heat to a compressed, labeled, and/or coined article or an annealed article to further compress a second layer 204. In an embodiment, the second layer 204 is a cellulose fiber article subject to compression, wherein a first layer 206 was applied via a labelling and/or coining process via the Labeling and Coining mold 136. The Final Compression Mold 138 may be used to further compress the second layer 204 to achieve a desired thickness. In some embodiments, it may be advantageous to partially compress the cellulose fiber article in a first compression mold 132, then subjecting the partially compressed cellulose fiber article to a labeling and coining process via the Labeling and Coining mold 136 before a final compression stage is complete in final compression mold 138. In such embodiments, complete compression of the cellulose article may not create ideal conditions for labeling and coining a thermoplastic layer on to the cellulose article. For example, complete compression of the cellulose article may reduce surface area of the cellulose article onto which the thermoplastic layer can be applied. Therefore, a final compression stage via a final compression mold 138 may be used to create a cellulose fiber and thermoplastic article with both ideal properties of a first layer 206 and a second layer 204 with the cellulose fiber and thermoplastic article achieving a desired thickness. element 138. A forming module 140 is the process by which a forming apparatus 130 forms an article comprised of a thermoplastic a cellulose material through a plurality of process steps, including compression, labeling, coining, and final compression. The forming module 140 may additionally describe a process of annealing the formed article through use of energetic treatments of the formed article, such as, for example, heating, pressurization, ultrasonic welding, etc. The forming module 140 may utilize any of injection molding, injection blow molding, injection stretch blow molding, compression molding, thermoforming, rotational molding or any other method of forming thermoplastic. The cellulose fiber article may be formed in a separate process, e.g., paper pulp molding. Alternatively, the cellulose fiber article may be formed into a pressed sheet or a formed article similar in shape, but slightly larger or smaller than the Compression Mold 132 such that the cellulose formed article will fit inside or outside at least a portion of the compression mold 132 so as to be compressed by the compression mold 132. In an alternate embodiment, a formed article comprised of pressed cellulose may be used as a mold for the thermoplastic material such that the thermoplastic material is thermoformed, or blow molded into the cavity formed by the cellulose formed article, using the cellulose formed article as a mold to create a formed article. Alternatively, a pressed cellulose sheet may be layered upon a thermoplastic sheet which may be heated and formed into a formed article by a Compression Mold 132 wherein the thermoplastic forming a pod exterior is bonded to the cellulose second layer 204 and simultaneously shaped into a formed article. element 140.

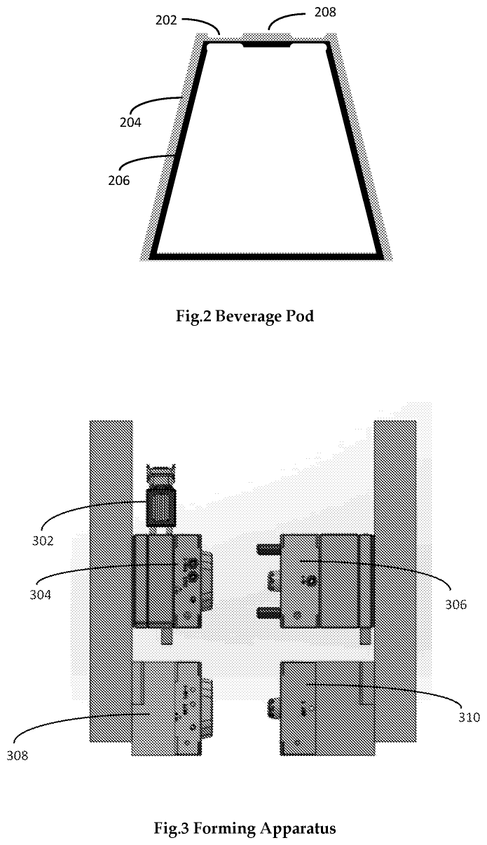

Functioning of the “beverage pod 102” will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 2 illustrates the beverage pod 102. Fused layers 202 are at least two layers of material which are heated and compressed such that they become fused or bonded in a manner that they are not easily separated. The compression additionally causes the fused layers 202 to decrease in thickness. In an embodiment, a first layer 206 is a thermoplastic material such as PLA, or a mixture of PLA and another thermoplastic material, such as, for example, PHB, and a second layer 204 is comprised of pressed cellulose fibers. The first layer 206 may be formed by using a labeling and/or coining process in an injection mold, such as Labeling and Coining Mold 136 while a cellulose article comprising the second layer 204 is placed within the Labeling and Coining Mold 136, the cellulose article comprising the second layer 204 providing a surface upon which the thermoplastic may be layered. The Labeling and Coining Mold 136 may apply compression force to the liquid thermoplastic used to label the first layer 206, creating a thinner second layer 204 by means of a coining process. In further embodiments, the first layer 206 and second layer 204 are each 1 mm and the resulting fused layers 202 is less than 0.75 mm. The first layer 206 and the second layer 204 may be interchangeable such that one may be on the interior of the formed article while the other is on the outside or vice versa. Similarly, if more than two layers comprise the fused layers 202, the order of each layer may similarly be interchanged. In further embodiments, the fused layers 202 comprise a mixture of thermoplastic and cellulose material combined before, during or after being formed into a formed article. 202. The second layer 204 is comprised of a cellulose material. In an embodiment, the cellulose material is pressed into the shape of a beverage pod, or another shape capable of being placed into compression mold 132. The second layer 204 may be initially of a size and thickness that exceeds the final desired size and thickness, such that the second layer 204 can be modified by the compression mold 132 into a desired size and thickness. The second layer 204 further may be designed to receive a thermoplastic label and/or coined first layer 206 in the Labeling and Coining Mold 134 before or after being compressed by the compression mold 132. In some embodiments, the second layer 204 may be further compressed after receiving the first layer 206 by means of a final compression mold 138. 204. The first layer 206 is comprised of a thermoplastic material or a mixture of multiple thermoplastic materials. The first layer 206 may additionally be comprised of one or more additives intended to improve one or more properties of the thermoplastic material. In an embodiment, the thermoplastic material is PLA. In other embodiments, the thermoplastic material may comprise a mixture of thermoplastics including PLA. The first layer 206 may further form the pod exterior 108 of a beverage pod 102. The first layer 206 may further be comprised of any material which may be used in a beverage pod 102 including those which may be used to form the pod exterior 108 of a beverage pod 102. The first layer 206 may be formed by labeling and/or coining a thermoplastic material on to the second layer 204. 206. The pod bottom 208 is the lowermost surface of a beverage pod 102 which is inserted first into the brewing chamber 126 of a beverage brewing machine 118. The pod bottom 208 is contacted by an outlet 128 pin which penetrates the pod bottom 208. In an embodiment, a region of fused layers 202 is located on the pod bottom 208 such that the outlet 128 pin of the beverage brewing machine 118 will contact the fused layers 202. In such embodiments, the fused layers 202 comprising an area of thinner material resulting from a compression of the first layer 206 and the second layer 204 such that the outlet 128 pin can more easily and reliably penetrate the pod bottom 208 of the beverage pod 102. 208.

Functioning of the “forming apparatus 130” will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 3 illustrates the forming apparatus 130. An injection nozzle 302 is a device comprising a gate for controlling the flow of melted thermoplastic material into a Labeling and Coining Mold 134. The injection nozzle 302 controls any of the pressure, flow rate, and amount of melted thermoplastic material which is forced into the Labeling and Coining Mold 134. The injection nozzle may additionally include sensors including temperature and pressure sensors and a heating element to ensure the thermoplastic remains at the desired temperature and to prevent clogging. The injection nozzle may be made of one of more of metal, metal alloys, or any heat resistant material including ceramics and heat resistant plastics. 302. A cavity forming mold 304 is one half of a Labeling and Coining Mold 134 for receiving a formed article, such as a cellulose fiber article. In an embodiment, the cavity forming mold 304 comprises the form to shape the pod exterior 108 of a beverage pod 102. The cavity forming mold 304 may be used with a core forming mold 306 in an injection molding process or may alternatively be used independently in a blow molding or thermoforming process. In some embodiments, the cavity forming mold 304 may be used to receive a second layer 204 comprised of cellulose fibers into which thermoplastic material is formed. In such processes, the thermoplastic will bond with the cellulose fibers to create a bond between the pod exterior 108 formed by the thermoplastic and the second layer 204 of the cellulose fiber resulting in an interior of thermoplastic and an exterior of cellulose fiber. 304. A core forming mold 306 is one half of a Labeling and Coining Mold 134 for forming the interior of a formed article. In an embodiment, the core forming mold 306 comprises the form to shape the interior of a beverage pod 102 pod exterior 108. The core forming mold 306 may be used with a cavity forming mold 304 in an injection molding process or may alternatively be used independently as a buck in a thermoforming process. In some embodiments, the core forming mold 306 may receive a second layer 204 comprised of cellulose fibers onto which thermoplastic material is formed in a labeling and/or coining process. In such processes, the thermoplastic will bond with the cellulose fibers to create a bond between the pod exterior 108 formed by the thermoplastic and the second layer 204 of the cellulose fiber resulting in an interior of cellulose fiber and an exterior of thermoplastic. 306. A Cavity Compression Mold 308 is one half of a Compression Mold 132 and/or final compression mold 138 for compressing a formed article comprised of a cellulose fiber and/or thermoplastic such as PLA. The Cavity Compression Mold 308 contacts the exterior of a formed article. In an embodiment, the formed article is the pod exterior 108 of a beverage pod 102 which is inserted into the Cavity Compression Mold 308 by a transfer actuator 134 so that the exterior surface is in contact with the Cavity Compression Mold 308. In an alternate embodiment, the Cavity Compression Mold 308 may also be the cavity forming mold 304. 308. A Core Compression Mold 310 is one half of a Compression Mold 132 and/or final compression mold 138 for compressing a formed article comprised of a cellulose fiber and/or thermoplastic such as PLA. The Core Compression Mold 310 contacts the interior of a formed article. In an embodiment, the formed article is the pod exterior 108 of a beverage pod 102, into which the Core Compression Mold 310 is inserted. In alternate embodiments, the Core Compression Mold 310 may also be the cavity forming mold 306. The transfer actuator 134 may alternatively place the formed article onto the Core Compression Mold 310 such that the interior surface of the formed article contacts the Core Compression Mold 310. In further embodiments, a second layer 204 comprised of cellulose fibers may be placed around the formed article such that the exterior of the formed article is in contact with the interior of the second layer 204 before being enclosed by the cavity annealing mold 308. 310.

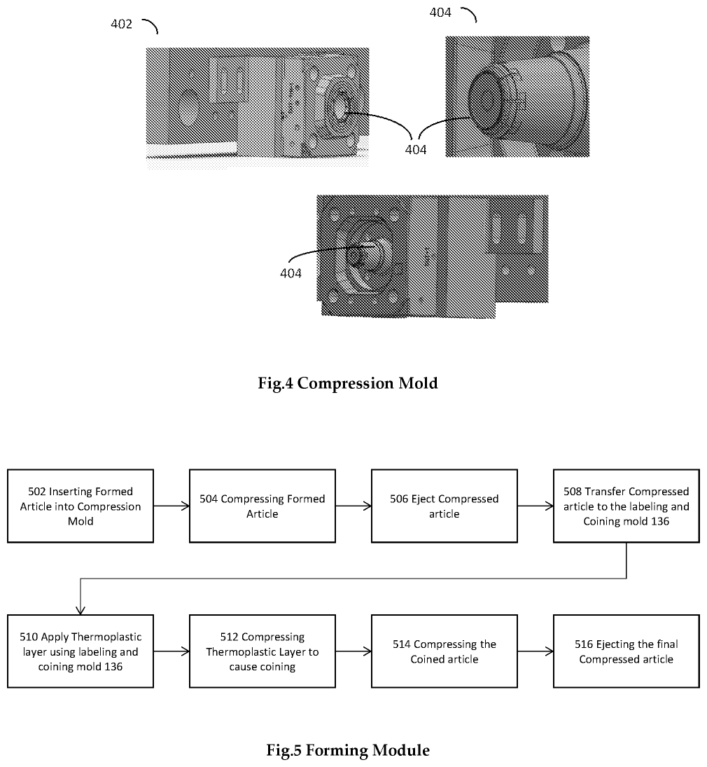

Functioning of the “Compression Mold 132” will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 4 illustrates the Compression Mold 132. A cavity compression mold 402 is the part of a Compression Mold 132 and/or final compression mold 138 which contacts the exterior of a formed article. In some embodiments, the cavity compression mold 402 may instead contact the exterior of a second layer 204 which is fused by a labeling and/or coining process to a thermoplastic first layer 206. The cavity compression mold 402 may additionally include one or more fusing elements 406 for fusing a first layer and a second layer 204 together using heat and/or pressure. The fusing elements 406 on the cavity compression mold 402 may align with corresponding fusing elements 406 on a core compression mold 404. The cavity compression mold 402 may include a heating element, which conducts heat to the cavity compression mold 402. The heating element may be electric or may utilize thermally conductive materials to transfer heat to the cavity compression mold 402. In an embodiment, the cavity compression mold 402 is used in tandem with a core compression mold 404 to compress a second layer 204 such that the second layer 204, comprised of cellulose fibers, is placed into the cavity compression mold 402 via a transfer actuator 134 and then a compressed by being enclosed by the core compression mold 404. 402. A core compression mold 404 is the part of a Compression Mold 132 and/or final compression mold 138 which contacts the interior of a formed article. In some embodiments, the core compression mold 404 may instead contact the interior of a second layer 204 which is to be fused to the interior of a formed article. The core compression mold 404 may additionally include one or more fusing elements 406 for fusing a first layer and a second layer 204 together using heat and/or pressure. The fusing elements 406 on the core compression mold 404 may align with corresponding fusing elements 406 on a cavity compression mold 402. Like the cavity compression mold 402, the core compression mold 404 may include a heating element, which conducts heat to the core compression mold 404. In an embodiment, the core compression mold 404 is used in tandem with a cavity compression mold 402 to compress a pod exterior 108 of a beverage pod 102 with a second layer 204 such that the formed article comprised of cellulose fibers is compressed by being enclosed by the cavity compression mold 402. The pod exterior 108 and the second layer 204 are fused together where the pod exterior 108 and/or second layer 204 contact one or more fusing elements 406. Additional layers may be introduced in any number of arrangements. 404. A fusing element 406 is a feature of a Compression Mold 132 and/or final compression mold 138 which is intended to use heat and/or pressure to fuse two or more layers of material together, such as a pod exterior 108 of a beverage pod 102 comprised of a thermoplastic material with a second layer 204 comprised of cellulose fibers. A fusing element 406 may comprise a heating element or alternatively a more thermally conductive material relative to the surrounding Labeling and Coining Mold 136 Compression Mold 132 and/or final compression mold 138 such that the fusing element 406 will increase in temperature more rapidly and will achieve a higher temperature than the surrounding Compression Mold 132 and/or final compression mold 138. The fusing element 406 may also be raised from the Compression Mold 132 and/or final compression mold 138 such as to ensure firm contact with the formed article and additionally apply pressure to the layers to be fused. In an embodiment, a cavity compression mold 402 and a core compression mold 404 arranged to compress and fuse together a pod exterior 108 and a second layer 204 of a beverage pod 102 each include two sets of corresponding fusing elements 406. The first set of fusing elements 406 are arranged to fuse the pod bottom so as to thin the material to allow penetration from an outlet 128 pin. The second set of fusing elements 406 are arranged to fuse the rim of the beverage pod 102 where a pod bond 106 will seal a pod lid 104 to the pod exterior 108 to create a sealed container once filled with a beverage material 116 and any additional functional elements such as a faceplate 112 and filter 114. 406.

Functioning of the “forming module 140” will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

FIG. 5 illustrates the forming module 140. The process begins with Inserting, in step 502, a formed cellulose article into a Compression Mold 132 via a transfer actuator 134 or other mechanism. The cellulose article may be an uncompressed beverage pod exterior. In an embodiment, an uncompressed cellulose beverage pod exterior is inserted into the Compression Mold 132 to form the pod exterior 108 of a beverage pod 102. 502. Compressing, in step 504, a formed article using a Compression Mold 132. The Compression Mold 132 containing a void space in the shape of the article to be compressed when a formed article is inserted. In an embodiment, the formed article is the pod exterior 108 of a beverage pod 102 formed of cellulose fiber. The Compression Mold 132 applies pressure sufficient to compress the formed article, reducing the thickness of the formed article. The formed article thereby retains the shape of the void space within the Compression Mold 132. In alternate embodiments, a second layer 204 comprised of pressed or loose cellulose fibers may be placed into the Compression Mold 132 to create a pod exterior 108 in the shape of the compression mold 132 void space. 504. Ejecting, in step 506, the compressed article from the Compression Mold 132. The compressed article may be loosened using pressurized air introduced through an orifice in the Compression Mold 132 to force air between the formed article and the Compression Mold 132. Alternatively, a mechanical ejection system may push the formed article away from the Compression Mold 132. In an embodiment, the formed article is the pod exterior 108 of a beverage pod 102 which is ejected using pressurized air to loosen the pod exterior 108 from the Compression Mold 132. 506. Transferring, in step 508, the formed article from the Compression Mold 132 to the Labeling and Coining Mold 136 using a transfer actuator 134. The transfer actuator 134 may comprise a movable end effector for gripping the formed article. Alternatively, the transfer actuator 134 may comprise a suction device for creating a vacuum between the end effector of the transfer actuator 134 and the formed article to securely grip the formed article using a suction force. In an embodiment, the formed article is the pod exterior 108 of a beverage pod 102. The pod exterior 108 is gripped by the end effector of the transfer actuator 134 comprised of at least two movable fingers, and the pod exterior 108 is removed from the Compression Mold 132 and placed into the Labeling and Coining Mold 136. In an alternate embodiment, the transfer actuator may instead move half of the Compression Mold 132 with the formed article stills secured to the Compression Mold 132 and mating the half of the Compression Mold 132 to a corresponding half of an Labeling and Coining Mold 136. In such an embodiment, the half of the Compression Mold 132 moved by the transfer actuator 134 also functions as half of the Labeling and Coining Mold 136. In alternate embodiments, the Compression Mold 132 may also function as the Labeling and Coining Mold 136 without the need for a transfer actuator 134 to move the article to a dedicated Labeling and Coining Mold 136. 508. Applying, in step 510, the first layer 206 to the compressed article using labeling and coining mold 136. The first layer 206 comprising thermoplastic material such as, for example, PLA. In an embodiment, the first layer 206 is injected into the Core Compression mold 404 of the using labeling and coining mold 136 to apply a thermoplastic layer to the interior of the compressed article. The labeling and coining mold 136 further applying pressure to the injected first layer 206 for create a thinner, coined first layer 206. Some embodiments may include more than two layers such as additionally including a dissolving layer or a layer of beverage material 116 pressed into the shape of the pod exterior 108. In an embodiment, a pressed cellulose second layer 204 may be inserted into the labeling and coining mold 136 prior to injecting the thermoplastic material. In other forming processes, the second layer 204 may be a sheet of pressed cellulose which may be layered with a sheet of malleable thermoplastic which may be simultaneously blow molded or thermoformed. Layers of cellulose fibers and thermoplastic may be alternated to form a composite formed article. 510. Compressing, in step 512, the thermoplastic layer by applying pressure to the thermoplastic layer within the Labeling and Coining Mold 136 to a specific pressure and temperature range for a predefined time period before allowing the formed article to cool to achieve desired properties including improving thermal resistance, malleability, ductility or hardness, and thickness. The pressure, temperature, and time period required will depend on the thermoplastic materials used to form the thermoplastic layer and the desired physical properties of the final coined article. In an embodiment, the thermoplastic layer is comprised of PLA. The thermoplastic layer is heated to a temperature of 90° C. for and compressed for 5 seconds before being ejected from the Labeling and Coining Mold 136 and allowed to cool to ambient temperatures below 60° C. The coining process may occur in the presence of a second layer 204 or may be completed before or after the addition of a second layer 204. 512. Compressing, in step 514, the coined article with the second layer 204 using at least one Final Compression Mold 138. The Final Compression Mold 138 applying heat and/or pressure from one or both sides of the formed article forcing the cellulose fibers of the second layer 204 to become compressed, reducing the thickness of the second layer 204. In an embodiment, the formed article is the pod exterior 108 of a beverage pod 102 comprised of PLA and the second layer 204 is comprised of pressed cellulose fibers. In some embodiments, the Final Compression Mold 138 is a pressure and/or heating stage of the Labeling and Coining Mold 136 that when engaged into a fully closed state, pressure is applied to the pod exterior 108 and the second layer 204 between the two opposing cavity compression mold 402 and core compression mold 404. The resulting heat and pressure causing the pod exterior 108 and second layer to fuse together and become thinner relative to the unfused parts of the beverage pod 102. In an embodiment, the pod exterior 108 and second layer 204 is compressed in at least a location where an outlet 128 pin is intended to contact the bottom of the beverage pod and around the top rim of the beverage pod 102 where a pod lid 104 will be affixed to the pod exterior 108 by a pod bond 106 after the beverage pod 102 has been filled with a beverage material 116. Alternatively, the Labeling and Coining Mold 136 may function as a Final Compression Mold 138 causing the entirety of the pod exterior 108 and the second layer 204 to be compressed. In alternate embodiments, the labeled and coined article may be transfer via the transfer actuators 134 from the labeling and coining mold 136 to the final compression mold 138. In alternate embodiments, the pod exterior 108 and second layer 204 may be labeled, coined, and compressed in the Compression Mold 132. In other embodiments utilizing processes other than injection molding, the second layer 204 may be fused with a thermoplastic article during the forming process, such as by layering and thermoforming the materials together, forming and fusing the layers in a single action. The same process may be utilized for blow molding. 514. Ejecting, in step 516, an article from the Labeling and Coining Mold 136 or Final Compression Mold 138. The compressed article may be removed with or without a transfer actuator 134 which may physically manipulate the compressed article. Alternatively, the compressed article may be loosened from the Labeling and Coining Mold 136 or final compression mold 138 using pressurized air and/or a mechanical ejection mechanism and allowed to fall away from an opened Labeling and Coining Mold 136 or final compression mold 138. In an embodiment, a compressed, labeled, coined and additionally compressed beverage pod 102 is ejected from the Labeling and Coining Mold 136 or final compression mold 138 using pressurized air which is then removed by a transfer actuator 134. 516.

What is claimed is:

1. An Article Comprising multiple material layers with reduced thickness comprising:
a. a first thermoplastic layer,
b. a second cellulose layer,
c. Wherein the first thermoplastic layer may be formed by a labeling and/or coining process via an injection molding apparatus, reducing the thickness of the first thermoplastic layer, the second cellulose layer subjected to compression either before, after, both before and after the first thermoplastic layer has been applied by a labeling and/or coining process, to further reduce the thickness of the first thermoplastic layer and the second cellulose layer.
